(19) United States
(12) Patent Application Publication
(10) Pub. No.: US 2026/0281540 A1
(43) Pub. Date: Sep. 17, 2026

(54) IMAGE CAPTURING APPARATUS THAT RECORDS FILE OF IMAGE DATA OBTAINED BY PRELIMINARY CONTINUOUS PHOTOGRAPHING, METHOD OF CONTROLLING IMAGE CAPTURING APPARATUS, AND STORAGE MEDIUM

(71) Applicant: CANON KABUSHIKI KAISHA, Tokyo (JP)

(72) Inventor: HIROYUKI FURUMOCHI, Tokyo (JP)

(21) Appl. No.: 19/439,748

(22) Filed: Jan. 5, 2026

(30) Foreign Application Priority Data
Jan. 15, 2025 (JP) 2025-005311

(51) Int. Cl. H04N 23/60; G06F 16/51

(52) U.S. Cl. CPC H04N 23/64; G06F 16/51

(57) ABSTRACT

An image capturing apparatus including a memory section that holds an image acquired by an image sensor as image data. Whether a storage state of the image data satisfies a predetermined condition is determined, and control to record the image data in a recording medium is performed. If it is determined that the storage state of the image data satisfies the predetermined condition, when a first image capturing instruction is received, a file number is added to image data acquired at each first image capturing interval, and the image data is recorded in the recording medium, whereas when a second image capturing instruction is received during the first image capturing instruction, a file number is added to image data acquired at each second image capturing interval different from the first image capturing interval, and the image data is recorded in the recording medium.

### CROSS REFERENCE TO RELATED APPLICATION

This application claims the benefit of Japanese Patent Application No. 2025-005311, filed Jan. 15, 2025, which is hereby incorporated by reference herein in its entirety.

### BACKGROUND

### Field of the Technology

The present disclosure relates to an image capturing apparatus that records a file of image data obtained by preliminary continuous photographing, a method of controlling the image capturing apparatus, and a storge medium.

### Description of the Related Art

In a digital camera and an electronic device equipped with a camera function (hereinafter collectively referred to as the “image capturing apparatus”), moving image photographing and still image photographing are performed. In the still image photographing, development processing is performed on an image output from an image sensor, and the developed image data is recorded in a recording medium. Further, the image capturing apparatus can also perform continuous photographing in which still image photographing is continuously performed, and in the continuous photographing, the still image photographing can be continuously performed with a setting of a continuous photographing speed, set e.g. to a value in a range of 30 fps to 60 fps.

Further, in the image capturing apparatus, it is possible to perform two-step button operations, i.e. an operation of halfway pressing a release button into a half pushed-in state and an operation of further deeply pressing the release button into a fully pushed-in state. In this image capturing apparatus, preliminary continuous photographing can also be performed in which when the release button is half-pressed, continuously photographed images are held in a buffer as image data, and when the release button is fully pressed, the image data held in the buffer is recorded in a recording medium. In the preliminary continuous photographing, not only image data obtained after the release button is fully pressed, but also image data obtained before the release button is fully pressed can be recorded in the recording medium, and hence it is possible to prevent missing of a decisive moment.

Further, there has been proposed a technique for changing a continuous photographing speed before and after the release button is fully pressed during the preliminary continuous photographing (Japanese Laid-Open Patent Publication No. 2001-257925). With the technique proposed by Japanese Laid-Open Patent Publication (Kokai) No. 2001-257925, it is possible, for example, to set the continuous photographing speed before the release button is fully pressed to 5 fps and set the continuous photographing speed after the release button is fully pressed to 30 fps.

Incidentally, in the preliminary continuous photographing, in many cases, at what timing before full pressing of the release button a decisive moment occurs is unknown, and a user sometimes desires to also record images captured before the release button is fully pressed in a recording medium at a low speed as the image data. In the technique disclosed in Japanese Laid-Open Patent Publication (Kokai) No. 2001-257925, it is possible to change the continuous photographing speed during the preliminary continuous photographing, but it is impossible to hold image data obtained before the release button is fully pressed in a buffer by high speed continuous photographing and, at the same time, record the image data in a recording medium at a low speed. On the other hand, there has been proposed a technique in which when the release button is half-pressed, while holding image data in a buffer at a continuous photographing speed of 30 fps, the image data is recorded in a recording medium at 5 fps which is different from the continuous photographing speed, and when the release button is fully pressed, the image data held in the buffer is recorded in the recording medium at the continuous photographing speed of 30 fps.

In the above-described technique, a file number is added to each item of image data to be originally recorded in the recording medium in the order of the photographing time. However, in the above-described technique, if recording is performed at a recording speed different from the continuous photographing speed during the preliminary continuous photographing, there is a concern that a file number different from the order of the photographing time is added to an item of image data recorded in the recording medium.

### SUMMARY

The present disclosure is directed to providing a mechanism that, in preliminary continuous photographing, in a case where the image data items are recorded at a recording speed different from a continuous photographing speed image, is capable of recording data items by adding a file number to each image data item in an order of the photographing time.

In a first aspect of the present disclosure, there is provided an image capturing apparatus, including an image capturing unit, a recording unit, a holding unit configured to hold an image acquired by the image capturing unit as an image data item, at least one processor; and a memory storing instructions that, when executed by the at least one processor, causes the at least one processor to function as a determination unit configured to determine whether or not a storage state of image data held in the holding unit satisfies a predetermined condition, and a control unit configured to perform control to record image data held in the holding unit in the recording unit, wherein the control unit adds, according to a first image capturing instruction, based on determination that the storage state of image data held in the holding unit satisfies the predetermined condition, a file number to an image data item acquired at each first image capturing interval, and records the image data item to which this file number has been added, in the recording unit, and adds, according to a second image capturing instruction provided during the first image capturing instruction, a file number to an image data item acquired at each second image capturing interval which is different from the first image capturing interval, and records the image data item to which this file number has been added, in the recording unit.

In a second aspect of the present disclosure, there is provided a method of controlling an image capturing apparatus including an image capturing unit, a recording unit, and a holding unit configured to hold an image acquired by the image capturing unit as an image data item, including determining whether or not a storage state of image data held in the holding unit satisfies a predetermined condition, and performing control to record image data held in the holding unit in the recording unit, wherein the control includes adding, according to a first image capturing instruction, based on determination that the storage state of image data held in the holding unit satisfies the predetermined condition, a file number to an image data item acquired at each first image capturing interval, and recording the image data item to which this file number has been added, in the recording unit, and adding, according to a second image capturing instruction provided during the first image capturing instruction, a file number to an image data item acquired at each second image capturing interval which is different from the first image capturing interval and, recording the image data item to which this file number has been added, in the recording unit.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram schematically showing a configuration of an image sensor included in an image capturing apparatus according to an embodiment of the present disclosure.

FIG. 2 is a diagram schematically showing a pixel array of the image sensor shown in FIG. 1.

FIG. 3 is a block diagram schematically showing a configuration of the image capturing apparatus according to the present embodiment.

FIG. 4 is a diagram showing an example of a menu screen displayed on a display section appearing in FIG. 3.

FIG. 5 is a diagram useful in explaining preliminary continuous photographing performed by the image capturing apparatus shown in FIG. 3.

FIG. 6 is a flowchart of a preliminary continuous photographing control process performed by the image capturing apparatus shown in FIG. 3.

FIG. 7 is a diagram showing an example of a setting screen displayed on the display section appearing in FIG. 3 for setting a preliminary continuous photographing time.

### DESCRIPTION OF THE EMBODIMENTS

The present disclosure will now be described in detail below with reference to the accompanying drawings showing embodiments thereof. Before describing a configuration of an image capturing apparatus according to an embodiment of the present disclosure, a configuration of an image sensor included in this image capturing apparatus will be described.

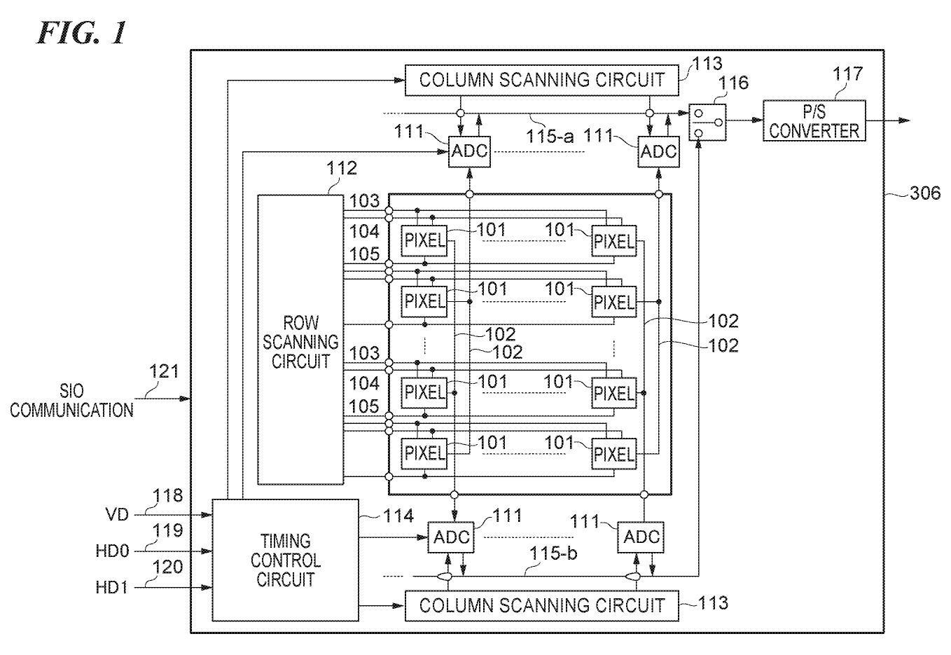

FIG. 1 is a block diagram schematically showing a configuration of the image sensor, denoted by reference numeral 306, which is included in the image capturing apparatus, denoted by reference numeral 300, according to the embodiment of the present disclosure.

Referring to FIG. 1, reference numeral 101 denotes a pixel, reference numeral 102 denotes a vertical output line, reference numeral 103 denotes a transfer signal line, reference numeral 104 denotes a reset signal line, and reference numeral 105 denotes a row selection signal line. Reference numeral 111 denotes a column analog-to-digital converter (ADC) block (hereinafter referred to “ADC”), reference numeral 112 denotes a row scanning circuit, reference numeral 113 denotes a column scanning circuit, reference numeral 114 denotes a timing control circuit, and reference numerals 115a-a and 115-b each denote a horizontal signal line. Reference numeral 116 denotes a changeover switch, and reference numeral 117 denotes a parallel/serial converter (hereinafter referred to the “P/S converter”).

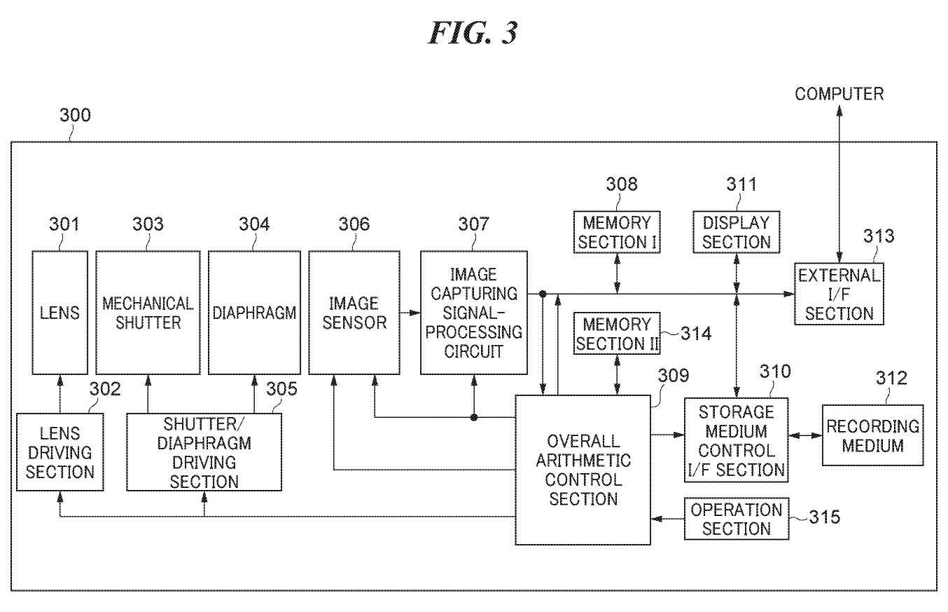

The timing control circuit 114 controls an image capturing timing of the image sensor 306 in synchronism with a VD signal (vertical synchronization signal) 118, an HD0 signal (horizontal synchronization signal 0) 119, and an HD1 signal (horizontal synchronization signal 1) 120, which are input from an overall arithmetic control section 309, described hereinafter with reference to FIG. 3. Reference numeral 121 denotes an SIO communication signal.

The image sensor 306 (image capturing unit) has the plurality of pixels 101 arranged in a matrix. Each pixel 101 is connected to respective associated ones of the transfer signal lines 103, the reset signal lines 104, and the row selection signal lines 105, in the horizontal direction (row direction), and is connected to an associated one of the vertical output lines 102 in the vertical direction (column direction). Note that each vertical output line 102 is connected to a different connection destination depending on a readout row unit.

Further, the image sensor 306 includes the ADC 111, the row scanning circuit 112, the column scanning circuit 113, the changeover switch 116, and the P/S converter 117.

The changeover switch 116 is a switch for outputting image signals output from the horizontal signal line 115-a and the horizontal signal line 115-b, respectively, for each channel. The image signals are output to the outside of the image sensor 306 after being parallelly/serially converted by the P/S converter 117 in synchronism with a signal output from the timing control circuit 114. Further, as the readout driving, driving for reading out all pixels, readout driving by thinning pixels to 1/3 or 1/5 thereof in the vertical direction, driving for vertically cropping pixels, and so forth can be selected.

The image sensor 306 has a standby state, a reading state, and an exposure state. In the standby state, the image sensor 306 does not perform readout of the pixels 101 and transfer of image data to an image capturing signal-processing circuit 307 appearing in FIG. 3, described hereinafter. In the reading state, the image sensor 306 performs exposure to and readout from the pixels 101 and performs transfer of image data to the image capturing signal-processing circuit 307, described hereinafter. In the exposure state, the image sensor 306 accumulates electric charges in the pixels 101 without performing readout of the pixels 101 and transfer of image data to the image capturing signal-processing circuit 307, described hereinafter.

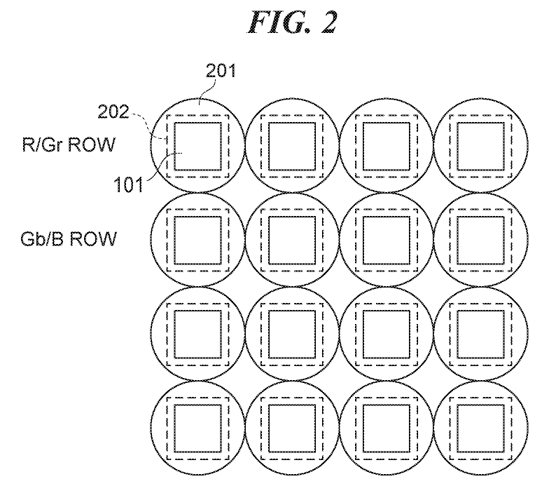

FIG. 2 is a diagram schematically showing the pixel array of the image sensor 306 shown in FIG. 1. A Bayer array is applied to color filters, and red (R) and green (Gr) color filters are alternately arranged on the pixels of odd rows sequentially from the left. Further, green (Gb) and blue (B) color filters are alternately arranged on the pixels of even rows sequentially from the left. Further, an on-chip microlens 201 is formed on each color filter 202.

FIG. 3 is a block diagram schematically showing a configuration of the image capturing apparatus 300 according to the present embodiment.

Referring to FIG. 3, the image capturing apparatus 300 includes a lens 301, a lens driving section 302, a mechanical shutter 303, a diaphragm 304, a shutter/diaphragm driving section 305, the image sensor 306, and the image capturing signal-processing circuit 307. Further, the image capturing apparatus 300 includes a memory section I 308 (holding unit), the overall arithmetic control section 309 (control unit), a storage medium control I/F section 310, a display section 311, a recording medium 312 (recording unit), an external I/F section 313, a memory section II 314, and an operation section 315.

Incident light passing through the lens 301 is adjusted to a proper light amount by the diaphragm 304 and forms an object image on an imaging surface of the image sensor 306. The object image formed on the imaging surface of the image sensor 306 is photoelectrically converted in the pixels 101, further subjected to gain adjustment and A/D conversion for converting signals from analog to digital, taken in as R, Gr, Gb, and B signals, and sent to the image capturing signal-processing circuit 307.

The image capturing signal-processing circuit 307 performs predetermined arithmetic processing using the captured image signals. The overall arithmetic control section 309 performs exposure control and ranging control based on an arithmetic operation result obtained by the arithmetic processing. With this, through-the-lens (TTL) auto exposure (AE) processing and flash auto light control emission (EF) processing are performed. The frame rate can be changed by increasing or reducing a time period of a VD signal 118 provided to the image signal 306 by the AE processing.

Further, the image capturing signal-processing circuit 307 performs predetermined arithmetic processing using captured image signals and performs TTL auto white balance (AWB) processing based on an obtained arithmetic operation result. Further, the image capturing signal-processing circuit 307 performs defective pixel correction and shading processing of the image sensor 306 and performs development processing. In the development processing, lowpass filter processing for reducing noise, sharpness correction for correcting blur of an object, contrast correction for adjusting contrast of an image, false color correction for correcting a false color, and so forth are performed.

The lens 301 is drivingly controlled by the lens driving section 302 to perform zooming, focusing, and so forth. The mechanical shutter 303 and the diaphragm 304 are drivingly controlled by the shutter/diaphragm driving section 305. The overall arithmetic control section 309 performs the overall control of the image capturing apparatus 300 and a variety of arithmetic operations. Further, the overall arithmetic control section 309 has a timer function and controls a recording speed timer for setting a recording interval of photographing.

The memory section I 308 temporarily stores (holds) image signals as image data. The storage medium control I/F section 310 records image data into the recording medium 312 and reads out the image data from the recording medium 312.

The display section 311 displays image data. As the display section 311, there are two types, i.e. an electronic view finder (EVF) and a liquid crystal display (LCD). The recording medium 312 is a removable storage medium, such as a semiconductor memory, and records image data. The external I/F section 313 is an interface for communicating with e.g. an external computer. The memory section II 314 stores a result of calculation performed by the overall arithmetic control section 309. Information related to a driving condition of the image capturing apparatus 300, which is set by a user on the operation section 315, is sent to the overall arithmetic control section 309, and the overall control of the image capturing apparatus 300 is performed based on these pieces of information.

The operation section 315 includes operation members, such as a menu button used by a user to make settings of the image capturing apparatus 300, a reproduction button to confirm a photographed image, and a release button to provide an image capturing instruction. In the image capturing apparatus 300, it is possible to perform two-step button operations, i.e. an operation of halfway pressing a release button into a half pushed-in state (release button half-pressing operation (SW1)) and an operation of further deeply pressing the release button into a fully pushed-in state (release button full-pressing operation (SW2)). The user can perform preliminary continuous photographing by performing the button operations of these two steps. In the preliminary continuous photographing, when the half-pressing operation (SW1) of the release button is performed, the image data is recorded, while being held in the memory section I 308 at a set second recording speed, in the recording medium 312 at a first recording speed different from the second recording speed. Further, when the fully pressing operation (SW2) of the release button is performed, the image data held in the memory section I 308 is recorded in the recording medium 312 at the second recording speed.

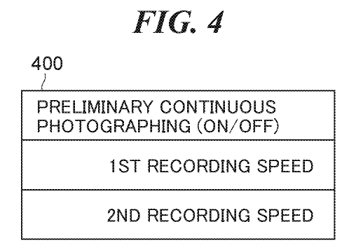

FIG. 4 is a diagram showing an example of a menu screen 400 displayed on the display section 311 appearing in FIG. 3.

The overall arithmetic control section 309 displays the menu screen 400 on the display section 311 according to an instruction input to the operation section 315 by the user. On the menu screen 400, the user can select whether or not to perform the preliminary continuous photographing, select the first recording speed, and select the second recording speed. The first recording speed is a recording speed after the half-pressing operation (SW1) of the release button is performed. The second recording speed is a recording speed after the fully pressing operation (SW2) of the release button is performed. Note that in the present embodiment, 60 [fps] is set to the second recording speed, and 15 [fps] lower than the second recording speed is set to the first recording speed, by way of example. The settings made on the menu screen 400 are stored in the memory section I 308.

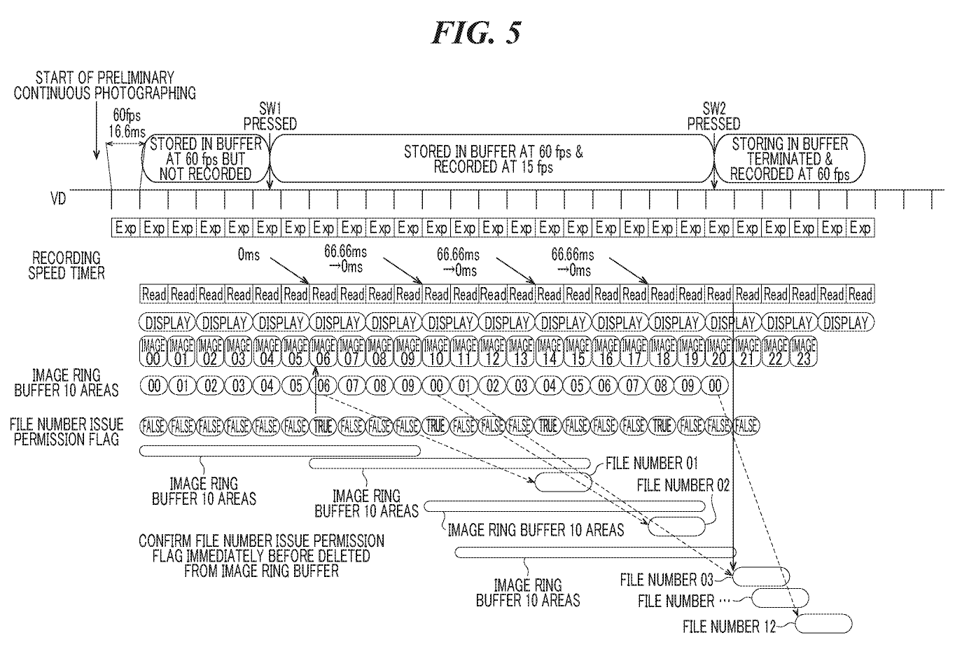

FIG. 5 is a diagram useful in explaining the preliminary continuous photographing performed by the image capturing apparatus 300 shown in FIG. 3.

In a case where execution of the preliminary continuous photographing is selected, and the first recording speed and the second recording speed are set on the menu screen 400, the image sensor 306, when during live view (LV), is driven to read out all pixels and controlled at the second recording speed.

In the memory section I 308, a temporary image storage area at the time of the preliminary continuous photographing is secured. In the present embodiment, it is assumed that an image ring buffer area having a capacity enough to store image data of ten still images is secured in the memory section I 308. In a case where a next image data item is temporarily stored (held) in a state in which the free capacity of the image ring buffer area is short, the image data is overwritten from the oldest to store the next image data item.

Further, in the memory section I 308, file number issue permission flags (identification information) are secured, which correspond in number to the buffers, for determining whether or not to issue a file number. The file number refers to a number added to each image data item to be recorded in the recording medium 312, out of images held in the image ring buffer area, according to the order of the photographing time. For example, a file number, such as 001, 002, and 003, is sequentially added to each image data item recorded in the recording medium 312 from the oldest image data item in the photographing time.

During LV, image data items are held in the image ring buffer area in the photographing order. However, in this state, the image data items are not recorded in the recording medium 312 yet. At this time, all the file number issue permission flags are set to FALSE.

When the user performs the half-pressing operation of the release button on the operation section 315 to start recording of the preliminary continuous photographing, a file number issue permission flag associated with an image data item is set to TRUE, starting with data of an image (an image 06 appearing in FIG. 5) read out when first exposure to the image sensor 306 is completed after the half-pressing operation of the release button.

At this time, the recording speed timer of the overall arithmetic control section 309 is operated according to the first recording speed. In the present embodiment, since the first recording speed is set to 15 [fps], 66.66 [ms] is set to the recording speed timer, and the recording speed timer is operated to perform countdown.

While the release button is being half-pressed, a value of the recording speed timer of the overall arithmetic control section 309 is confirmed when an image captured at the second recording speed is held in the image ring buffer area as the image data.

If the value of the recording speed timer of the overall arithmetic control section 309 is not 0, the associated file number issue permission flags are set to FALSE, whereas if the value of the recording speed timer of the overall arithmetic control section 309 is 0, the associated file number issue permission flags are set to TRUE.

Further, if the value of the recording speed timer of the overall arithmetic control section 309 is 0, the recording speed timer of the overall arithmetic control section 309 is operated again according to the first recording speed.

While the release button is being half-pressed, when a next image data item is held (overwritten and saved) in a state in which the free capacity area of the image ring buffer area of the memory section I 308 is short, a file number is added to an image data item for which the file number issue permission flag is set to TRUE, and this image data item is recorded in the recording medium 312.

After that, when the user performs the fully pressing operation of the release button on the operation section 315 to terminate recording of the preliminary continuous photographing, file numbers are added to image data items sequentially from the oldest image data item in the image ring buffer area, and the image data items are recorded in the recording medium 312. At this time, confirmation of the values of the file number issue permission flags is not performed, and the image data items are recorded at the second recording speed.

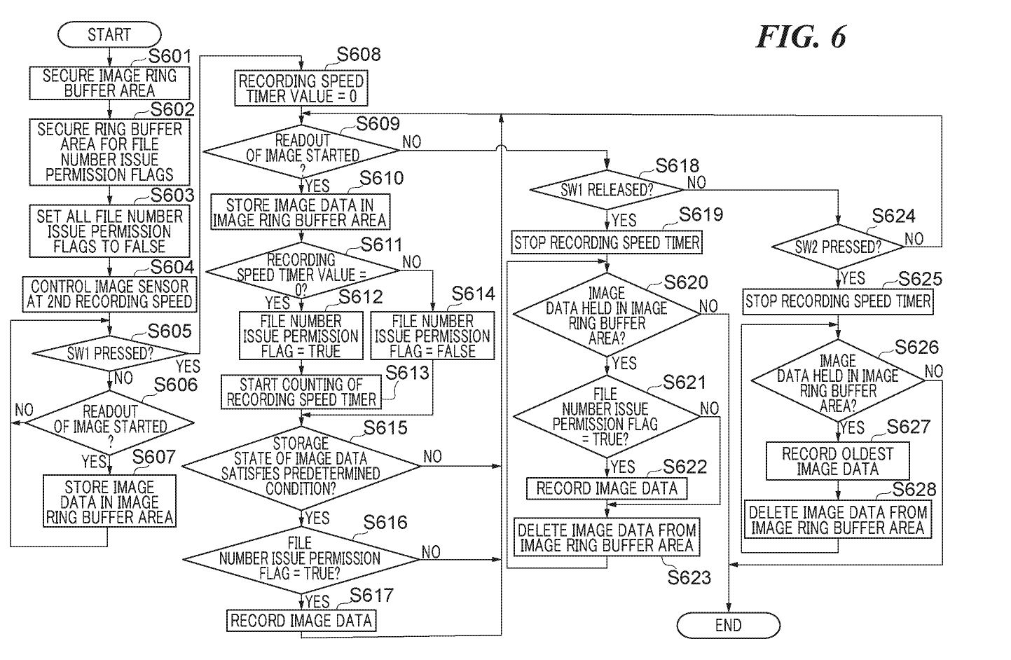

FIG. 6 is a flowchart of a preliminary continuous photographing control process performed by the image capturing apparatus 300 shown in FIG. 3. The preliminary continuous photographing control process in FIG. 6 is realized by the overall arithmetic control section 309 that executes a program stored e.g. in a memory (not shown) of the overall arithmetic control section 309. The preliminary continuous photographing control process in FIG. 6 is started when the user performs an operation of closing the menu screen 400 in a state in which execution of preliminary continuous photographing is selected, and the first recording speed and the second recording speed are set, respectively, on the menu screen 400. Note that as described above, 60 [fps] which is the same as the continuous photographing speed is set to the second recording speed, and 15 [fps] lower than the second recording speed is set to the first recording speed.

Referring to FIG. 6, first, the overall arithmetic control section 309 secures the image ring buffer area in the memory section I 308 (S601). In the step S601, as described above, the image ring buffer area having a capacity enough to store image data of ten still images is secured in the memory section I 308.

Then, the overall arithmetic control section 309 secures a ring buffer area for the file number issue permission flags (S602). Then, the overall arithmetic control section 309 sets all of the file number issue permission flags to FALSE (S603).

Then, the overall arithmetic control section 309 controls the image sensor 306 at the second recording speed set on the menu screen 400 (S604). With this, the image sensor 306 reads out images at the second recording speed.

Then, the overall arithmetic control section 309 determines whether or not the user has performed the half-pressing operation (SW1) of the release button on the operation section 315 (S605). If it is determined in the step S605 that the user has not performed the half-pressing operation (SW1) of the release button on the operation section 315, the present process proceeds to a step S606.

In the step S606, the overall arithmetic control section 309 determines whether or not readout of an image has been started by the image sensor 306. If it is determined in the step S606 that readout of an image has not been started by the image sensor 306, the present process returns to the step S605. If it is determined in the step S606 that readout of an image has been started by the image sensor 306, the present process proceeds to a step S607.

In the step S607, the overall arithmetic control section 309 stores the image acquired by the image sensor 306 in the image ring buffer area as an image data item. After that, the present process returns to the step S605.

If it is determined in the step S605 that the user has performed the half-pressing operation (SW1) of the release button on the operation section 315, the present process proceeds to a step S608.

In the step S608, the overall arithmetic control section 309 sets the value of the recording speed timer of the overall arithmetic control section 309 to 0.

Then, the overall arithmetic control section 309 determines whether or not readout of an image has been started by the image sensor 306 (S609). If it is determined in the step S609 that readout of an image has been started by the image sensor 306, the present process proceeds to a step S610.

In the step S610, the overall arithmetic control section 309 stores an image acquired by the image sensor 306 in the image ring buffer area as an image data item.

Then, the overall arithmetic control section 309 determines whether or not the value of the recording speed timer is 0 (S611). If it is determined in the step S611 that the value of the recording speed timer is 0, the overall arithmetic control section 309 sets the file number issue permission flag to TRUE (S612).

Then, the overall arithmetic control section 309 starts the operation of the recording speed timer of the overall arithmetic control section 309 (S613). As described above, the overall arithmetic control section 309 operates this recording speed timer based on the first recording speed. In the present embodiment, since the first recording speed is set to 15 [fps], the overall arithmetic control section 309 sets 66.66 [ms] to the recording speed timer, and the recording speed timer is operated to perform countdown. Then, the present process proceeds to a step S615, described hereinafter.

If it is determined in the step S611 that the value of the recording speed timer is not 0, the overall arithmetic control section 309 sets the file number issue permission flag to FALSE (S614). Thus, in the present embodiment, in a case where the value of the recording speed timer is 0, the file number issue permission flag is set to TRUE. For example, in a case where the user has performed the half-pressing operation of the release button on the operation section 315, the file number issue permission flag is set to TRUE with respect to an image data item of an image (the image 06 appearing in FIG. 5) read out thereafter when first exposure to the image sensor 306 is completed. Further, in a case where the value of the recording speed timer operating based on the first recording speed becomes 0, that is, with respect to image data acquired at a first image capturing interval corresponding to the first recording speed, the file number issue permission flag is set to TRUE.

Then, the overall arithmetic control section 309 determines whether or not the storage state of image data in the image ring buffer area satisfies a predetermined condition (S615). In the present embodiment, for example, as the predetermined condition, a condition concerning a remaining capacity of the image ring buffer area has been set in advance. In the step S615, for example, in a case where an image data item held in the image ring buffer area is not to be overwritten by a next image data item, i.e. in a case where in the remaining capacity of the image ring buffer area is enough to store the next image data item, it is determined that the storage state of image data in the image ring buffer area does not satisfy the predetermined condition. In this case, the present process returns to the step S609. On the other hand, in a case where image data held in the image ring buffer area is to be overwritten by a next image data item, i.e. in a case where the remaining capacity of the image ring buffer area is not enough to store the next image data item, it is determined that the storage state of image data in the image ring buffer area satisfies the predetermined condition. In this case, the present process proceeds to a step S616.

In the step S616, the overall arithmetic control section 309 determines whether or not the file number issue permission flag of the oldest one of the image data items held in the image ring buffer area is TRUE. If it is determined in the step S616 that the file number issue permission flag of the oldest one of the image data items held in the image ring buffer area is not TRUE, i.e. this file number issue permission flag is FALSE, the present process returns to the step S609.

If it is determined in the step S616 that the file number issue permission flag of the oldest one of the image data items held in the image ring buffer area is TRUE, the present process proceeds to a step S617.

In the step S617, the overall arithmetic control section 309 adds a file number to this image data item and records this image data item to which the file number has been added, in the recording medium 31. After that, the present process returns to the step S609.

If it is determined in the step S609 that readout of an image has not been started by the image sensor 306, the present process proceeds to a step S618.

In the step S618, the overall arithmetic control section 309 determines whether or not the half-pressing operation (SW1) of the release button on the operation section 315 has been released. If it is determined that the half-pressing operation (SW1) of the release button on the operation section 315 has been released, the present process proceeds to a step S619.

In the step S619, the overall arithmetic control section 309 stops the recording speed timer of the overall arithmetic control section 309. Then, the overall arithmetic control section 309 determines whether or not image data is held in the image ring buffer area (S620). If it is determined that image data is not held in the image ring buffer area, the present process is terminated. If it is determined that image data is held in the image ring buffer area, the present process proceeds to a step S621.

In the step S621, the overall arithmetic control section 309 determines whether or not the file number issue permission flag of the oldest one of the image data items held in the image ring buffer area is TRUE. If it is determined that the file number issue permission flag of the oldest one of the image data items held in the image ring buffer area is TRUE, the present process proceeds to a step S622.

In the step S622, the overall arithmetic control section 309 adds a file number to this image data item and records the image data item to which the file number has been added, in the recording medium 312. Then, the overall arithmetic control section 309 deletes the image data item from the image ring buffer area (S623). After that, the present process returns to the step S620.

If it is determined in the step S621 that the file number issue permission flag of the oldest one of the image data items held in the image ring buffer area is not TRUE, i.e. this file number issue permission flag is FALSE, the present process proceeds to the step S623.

If it is determined in the step S618 that the half-pressing operation (SW1) of the release button on the operation section 315 has not been released, the present process proceeds to a step 624.

In the step S624, the overall arithmetic control section 309 determines whether or not the user has performed the fully pressing operation (SW2) of the release button on the operation section 315. If it is determined that the user has not performed the fully pressing operation (SW2) of the release button on the operation section 315, the present process returns to the step S609. If it is determined that the user has performed the fully pressing operation (SW2) of the release button on the operation section 315, the present process proceeds to a step S625.

In the step S625, the overall arithmetic control section 309 stops the recording speed timer of the overall arithmetic control section 309. Then, the overall arithmetic control section 309 determines whether or not image data is held in the image ring buffer area (S626). If it is determined that image data is held in the image ring buffer area, the present process proceeds to a step S627.

In the step S627, the overall arithmetic control section 309 adds a file number to the oldest one of the image data items held in the image ring buffer area and records this image data item in the recording medium 312. Then, the overall arithmetic control section 309 deletes the image data item recorded in the recording medium 312 from the image ring buffer area (S628). After that, the present process returns to the step S626.

If it is determined in the step S626 that image data is not held in the image ring buffer area, the present process is terminated.

According to the above-described embodiment, in a case where it is determined that the storage state of image data held in the image ring buffer area according to the half-pressing operation of the release button satisfies the predetermined condition, a file number is added to an image data item acquired at each first image capturing interval based on the first recording speed, and the image data item to which the file number has been added is recorded in the recording medium 312. Further, in a case where the fully pressing operation of the release button is performed during the half-pressing operation of the release button (during the first image capturing instruction), a file number is added to an image data item acquired at each second image capturing interval based on the second recording speed, and the image data item to which this file number has been added is recorded in the recording medium 312. With this, in the preliminary continuous photographing, it is possible to record image data items with respective file numbers added in the order of the photographing time, in a case where the image data items are recorded at the first recording speed different from the second recording speed.

Further, in the above-described embodiment, according to the half-pressing operation of the release button, a file number issue permission flag is added to an image data item held in the image ring buffer area at each first image capturing interval. In a case where it is determined that the storage state of image data in the image ring buffer area satisfies the predetermined condition, a file number is added to an image data with the file number issue permission flag set to TRUE, and the image data item to which this file number is added is recorded in the recording medium 312. With this, when an image data item is recorded at the first recording speed, it is possible to record the image data item with the file number added in the order of the photographing time.

Further, in the above-described embodiment, according to the fully pressing operation of the release button during the half-pressing operation of the release button, file numbers are added to image data items held in the image ring buffer area sequentially from the oldest, and the image data items to which the file numbers are added are recorded in the recording medium 312. With this, when image data items are recorded at the second recording speed after being recorded at the first recording speed, it is possible to record the image data items with file numbers added in the order of the photographing time.

Further, in the above-described embodiment, the first image capturing interval is larger than the second image capturing interval, and hence in the preliminary continuous photographing, in a case where an image data item is recorded at the first recording speed lower than the second recording speed, it is possible to record the image data item with a file number added in the order of the photographing time.

Further, in the above-described embodiment, in a case where an image data item held in the image ring buffer area is to be overwritten by a next image data item, it is determined that the storage state of image data in the image ring buffer area satisfies the predetermined condition. That is, with respect to an image data item which is held in the image ring buffer area and is to be overwritten by a next image data item, it is determined in the step S616, before the image data item is overwritten, whether or not the file number issue permission flag of this image data item is TRUE. With this, in a case where the file number issue permission flag of this image data item is TRUE, it is possible to add a file number to this image data item and record the image data item to which the file number is added in the recording medium 312 before the image data item is overwritten.

Note that although in the above-described embodiment, the condition concerning the remaining capacity of the image ring buffer area is used as the predetermined condition in the determination in the step S615, the predetermined condition is not limited to this. For example, a condition concerning the number of image data items held in the image ring buffer area can be used. When this condition is used, in the step S615, for example, in a case where the number of image data items held in the image ring buffer area is equal to or larger than a predetermined number, it is determined that the storage state of image data in the image ring buffer area satisfies the predetermined condition. For example, this is a case where the image ring buffer area which can store ten image data items is secured in the memory section I 308, and a predetermined number or more, e.g. eight or more image data items are held in this image ring buffer area. In a state in which two image data items can be stored as remaining image data items in the image ring buffer area secured in the memory section I 308, as described above, file numbers are added to image data items having the file number issue permission flag set to TRUE, and the image data items to which the file numbers have been added are recorded in the recording medium 312. Note that this predetermined number is determined in advance by taking into account variation in the processing of recording image data items in the recording medium 312. By using the above-described condition, before an image data item having the file number issue permission flag set to TRUE is overwritten, it is possible to add a file number to the image data item and record the image data item to which the file number has been added, in the recording medium 312.

Further, in the above-described embodiment, in the determination in the step S615, a condition concerning the total size of image data items held in the image ring buffer area can be used as the predetermined condition. When this condition is used, in the step S615, for example, in a case where the total size of image data items held in the image ring buffer area becomes equal to or larger than a predetermined size, it is determined that the storage state of image data in the image ring buffer area satisfies the predetermined condition. For example, this is a case where the image ring buffer area having the capacity of 100 [MB] is secured in the memory section I 308, and the total size of image data items held in the image ring buffer area becomes 80 [MB] or more. In a state in which the remaining capacity of the image ring buffer secured in the memory section I 308 becomes 20 [MB] as mentioned above, a file number is added to an image data item having the file number issue permission flag set to TRUE, and this image data item to which the file number has been added is recorded in the recording medium 312. Note that this predetermined size is determined in advance by taking into account variation in the processing of recording image data in the recording medium 312. By using the above-described condition, before an image data item having the file number issue permission flag set to TRUE is overwritten, it is possible to add a file number to the image data and record the image data item to which the file number has been added, in the recording medium 312.

Further, in the above-described embodiment, in the determination in the step S615, a condition concerning a time period during which image data has been held in the image ring buffer area can be used as the predetermined condition. When this condition is used, in the step S615, for example, in a case where the time period during which image data has been held in the image ring buffer area is equal to or longer than a predetermined time period, it is determined that the storage state of image data in the image ring buffer area satisfies the predetermined condition. For example, this is a case where the time period during which image data has been held in the image ring buffer area is 1.0 second or more. Here, in a configuration in which the preliminary continuous photographing time can be set, in a case where the preliminary continuous photographing time is set to 1.0 second, it is not necessary to record image data held before 1.0 second or more in the recording medium 312. Thus, when the preliminary continuous photographing time is set, the above-described condition is used.

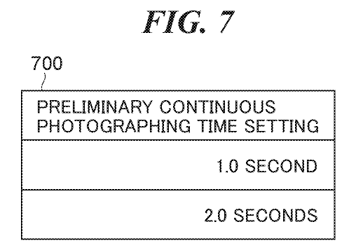

FIG. 7 is a diagram showing an example of a setting screen 700 for setting the preliminary continuous photographing time, which is displayed on the display section 311 appearing in FIG. 3.

The overall arithmetic control section 309 displays the setting screen 700 on the display section 311 according to an instruction input by the user on the operation section 315.

On the setting screen 700, one of 1.0 second and 2.0 seconds is selected by the user as the preliminary continuous photographing time. A setting made on the setting screen 700 is stored in the memory section I 308.

In a case where, in the determination in the step S615, the condition concerning the time period in which image data has been held in the image ring buffer area is used as the predetermined condition, a file number is added to an image data item which has been held in the image ring buffer area for 1.0 second or more and has the file number issue permission flag set to TRUE, and the image data item to which the file number has been added is recorded in the recording medium 312. By using this condition, it is possible to prevent, based on the preliminary continuous photographing time set by the user, unnecessary image data which is not intended by a user from being recorded in the recording medium 312.

Note that the condition used in the step S615 can be set for the image capturing apparatus 300 in advance or can be set by the user operating the operation section 315.

According to the present disclosure, in the preliminary continuous photographing, in a case where an image data item is recorded at a recording speed different from a continuous photographing speed, it is possible to record the image data item with a file number added in the order of photographing time.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An image capturing apparatus, including:
an image capturing unit;
a recording unit;
a holding unit configured to hold an image acquired by the image capturing unit as an image data item;
at least one processor; and
a memory storing instructions that, when executed by the at least one processor, causes the at least one processor to function as:
a determination unit configured to determine whether or not a storage state of image data held in the holding unit satisfies a predetermined condition; and
a control unit configured to perform control to record image data held in the holding unit in the recording unit,
wherein the control unit adds, according to a first image capturing instruction, based on determination that the storage state of image data held in the holding unit satisfies the predetermined condition, a file number to an image data item acquired at each first image capturing interval, and records the image data item to which this file number has been added, in the recording unit, and adds, according to a second image capturing instruction provided during the first image capturing instruction, a file number to an image data item acquired at each second image capturing interval which is different from the first image capturing interval, and records the image data item to which this file number has been added, in the recording unit.

2. The image capturing apparatus according to claim 1, wherein the control unit adds identification information to an image data item held in the holding unit at the first image capturing interval according to the first image capturing instruction, and in a case where it is determined that the storage state of image data held in the holding unit satisfies the predetermined condition, the control unit adds a file number to the image data item to which the identification information has been added and records the image data to which the file number has been added in the recording unit.

3. The image capturing apparatus according to claim 1, wherein the control unit adds file numbers to image data items held in the holding unit sequentially from the oldest image data item, and records the image data items to which the file numbers have been added, respectively, in the recording unit according to the second instruction provided during the first image capturing instruction.

4. The image capturing apparatus according to claim 1, wherein the first image capturing interval is larger than the second image capturing interval.

5. The image capturing apparatus according to claim 1, wherein, in a case where an image data item held in the holding unit is to be overwritten by a next image data item, the determination unit determines that the storage state of the image data item held in the holding unit satisfies the predetermined condition.

6. The image capturing apparatus according to claim 1, wherein, in a case where the number of image data items held in the holding unit is equal to or larger than a predetermined number set in advance, the determination unit determines that the storage state of image data held in the holding unit satisfies the predetermined condition.

7. The image capturing apparatus according to claim 1, wherein, in a case where the total size of image data items held in the holding unit is equal to or larger than a predetermined size set in advance, the determination unit determines that the storage state of image data held in the holding unit satisfies the predetermined condition.

8. The image capturing apparatus according to claim 1, wherein, in a case where a time period during which image data has been held in the holding unit is equal to or longer than a predetermined time period set in advance, the determination unit determines that the storage state of image data held in the holding unit satisfies the predetermined condition.

9. A method of controlling an image capturing apparatus including an image capturing unit, a recording unit, and a holding unit configured to hold an image acquired by the image capturing unit as an image data item, comprising:
determining whether or not a storage state of image data held in the holding unit satisfies a predetermined condition; and
performing control to record image data held in the holding unit in the recording unit,
wherein the control includes adding, according to a first image capturing instruction, based on determination that the storage state of image data held in the holding unit satisfies the predetermined condition, a file number to an image data item acquired at each first image capturing interval, and recording the image data item to which this file number has been added, in the recording unit, and adding, according to a second image capturing instruction provided during the first image capturing instruction, a file number to an image data item acquired at each second image capturing interval which is different from the first image capturing interval and, recording the image data item to which this file number has been added, in the recording unit.

10. A non-transitory computer-readable storage medium storing a program for causing a computer to execute a method of controlling an image capturing apparatus including an image capturing unit, a recording unit, and a holding unit configured to hold an image acquired by the image capturing unit as an image data item,
wherein the method comprises:
determining whether or not a storage state of image data held in the holding unit satisfies a predetermined condition; and
performing control to record image data held in the holding unit in the recording unit,
wherein the control includes adding, according to a first image capturing instruction, based on determination that the storage state of image data held in the holding unit satisfies the predetermined condition, a file number to an image data item acquired at each first image capturing interval, and recording the image data item to which this file number has been added, in the recording unit, and adding, according to a second image capturing instruction provided during the first image capturing instruction, a file number to an image data item acquired at each second image capturing interval which is different from the first image capturing interval and, recording the image data item to which this file number has been added, in the recording unit.
